(19) United States
(12) Patent Application Publication
(10) Pub. No.: US 2009/0232402 A1
(43) Pub. Date: Sep. 17, 2009

(54) Image Processing Apparatus, Image Processing Method, and Computer Program for Image Processing

(75) Inventor: Masatoshi Matsuhira, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/402,329

(22) Filed: Mar. 11, 2009

(30) Foreign Application Priority Data
Mar. 14, 2008 (JP) 2008-066204

(51) Int. Cl. G06K 9/46; G06F 3/12

(52) U.S. Cl. 382/203; 358/1.1

(57) ABSTRACT

An image processing apparatus. A facial area detecting unit detects a facial area containing an image of at least a part of a face of a person in a target image. A size calculating unit calculates a size reference value correlated with an actual size of the face by using the target image and relevant information on the target image. An image processing unit performs a specific process on the target image in accordance with the size reference value.

### CROSS-REFERENCE TO RELATED APPLICATIONS

This application claims the benefit of priority under 35 USC 119 of Japanese application no. 2008-066204, filed on Mar. 14, 2008, which is incorporated herein by reference.

### BACKGROUND

1. Technical Field

The present invention relates to an image processing apparatus and method, and a computer program for image processing.

2. Related Art

Various image processes are known, such as color correcting and subject deforming processes. Image processes are not limited to image correcting processes, and also include processes such as image outputting (including printing and display processes) and classifying processes. JP-A-2004-318204 is an example of related art in this field.

A subject copied into an image sometimes has various characteristics. For example, the subject may include a person, and the person may be large or small. However, a sufficient study of fitting the image process to the characteristics of the particular subject has not been made.

### SUMMARY

The present invention provides techniques for fitting an image process to the characteristics of a subject.

According to one aspect of the invention, an image processing apparatus is provided including: a facial area detecting unit that detects a facial area containing an image of at least a part of a face of a person in a target image; a size calculating unit that calculates a size reference value correlated with an actual size of the face by using the target image and relevant information on the target image; and an image processing unit that performs a specific process on the target image in accordance with the size reference value.

With such a configuration, since the specific process is performed on the target image in accordance with the size reference value correlated with the actual size of the face, the process on the target image can be fitted to the actual size of the face. As a result, the image process can be fit to characteristics of the subject.

In one embodiment of the image processing apparatus, the image processing unit performs a first process when the size reference value is present within a first range.

With such a configuration, when the size reference value is within the first range, the first process can be intentionally performed on the image representing a face of the actual size corresponding to the size reference value within the first range.

In another embodiment of the image processing apparatus, when the size reference value is present within a second range that does not overlap with the first range, the image processing unit performs a second process different from the first process.

With such a configuration, when the size index value is within the second range, a second process different from the first process is intentionally performed on the image representing a face of the actual size corresponding to the size index value within the second range.

In another embodiment of the image processing apparatus, the image processing unit performs as the first process a sharpness emphasis process on at least a part of the face in the target image.

With such a configuration, at least the part of the face of the actual size corresponding to the size reference value within the first range is allowed to be clear.

In another embodiment of the image processing apparatus, the second range is broader than the first range, and the image processing unit performs as the second process a process of reducing at least a part of the face in the target image.

With such a configuration, at least the part of the face of the actual size corresponding to the size reference value within the second range is reduced.

In another embodiment of the image processing apparatus, the target image is an image created by an image pickup device. The relevant information includes image pickup distance information on a distance from the image pickup device to the person at the time of photographing the target image, focal distance information on a lens focal distance of the image pickup device at the time of photographing the target image, and an image pickup element information on a size of a portion in which the target image of a light-receiving area in an image pickup element of the image pickup device is created. The size calculating unit calculates the size reference value by using the relevant information and a size on the target image reflecting a size of the face.

With such a configuration, the size reference value is properly calculated in accordance with the relevant information.

According to another aspect of the invention, a printer is provided including: a facial area detecting unit that detects a facial area containing an image of at least a part of a face of a person in a target image; a size calculating unit that calculates a size reference value correlated with an actual size of the face by using the target image and relevant information on the target image; an image processing unit that performs a specific process on the target image in accordance with the size reference value; and a printing unit that prints the target image subjected to the specific process performed by the image processing unit.

According to still another aspect of the invention, an image processing method is provided including: detecting a facial area containing an image of at least a part of a face of a person in a target image; calculating a size reference value correlated with an actual size of the face by using the target image and relevant information on the target image; and performing a specific process on the target image in accordance with the size reference value.

According to still another aspect of the invention, an image processing computer program embodied on a computer-readable medium is provided. The program causes a computer to execute: a function of detecting a facial area containing an image of at least a part of a face of a person in a target image; a function of calculating a size reference value correlated with an actual size of the face by using the target image and relevant information on the target image; and a function of performing a specific process on the target image in accordance with the size reference value.

The invention may be implemented in various forms such as an image processing method, an image processing apparatus, a computer program for executing the functions of the image processing method or apparatus, and a recording medium having the computer program recorded therein.

### BRIEF DESCRIPTION OF THE DRAWINGS

The invention will be described with reference to the accompanying drawings, wherein like numbers reference like elements.

FIG. 1 is a block diagram of a printer according to a first embodiment of the invention.

FIG. 2 is an block diagram of modules and data stored in a ROM.

FIG. 3 is a schematic diagram including a model size table.

FIG. 4 is a flowchart of a printing process.

FIGS. 5A and 5B are schematic diagrams illustrating detection results of facial areas.

FIG. 6 is an explanatory diagram illustrating a relation between the number of pixels on an image and an actual size of the image.

FIG. 7 is a schematic diagram illustrating deformation, color correction and shading processes.

FIG. 8 is a schematic diagram illustrating a process of detecting and emphasizing the sharpness of an eye area.

FIG. 9 is a flowchart of a printing process according to a second embodiment of the invention.

FIG. 10 is a schematic diagram illustrating a process on the basis of an actual size according to a third embodiment of the invention.

FIG. 11 is a block diagram illustrating a digital still camera according to a fourth embodiment of the invention.

### DESCRIPTION OF EXEMPLARY EMBODIMENTS

Exemplary embodiments of the invention are described herein as follows:
A. First Embodiment;
B. Second Embodiment;
C. Third Embodiment;
D. Fourth Embodiment; and
E. Modified Examples.

### A. First Embodiment

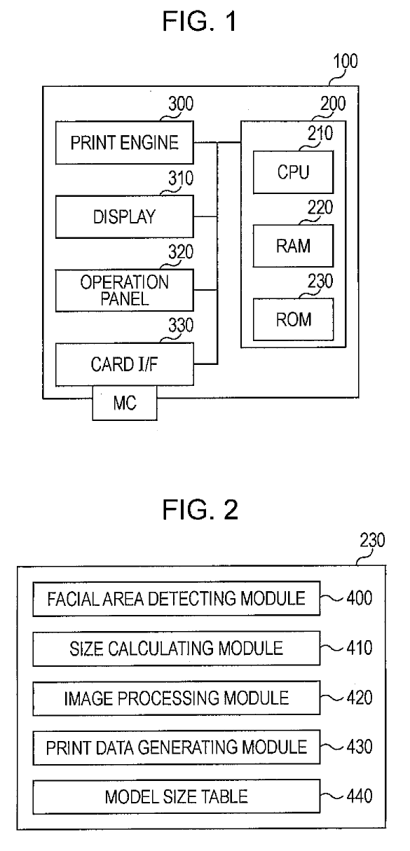

FIG. 1 is a block diagram of a printer 100 according to a first embodiment of the invention. The printer 100 includes a control unit 200, a print engine 300, a display 310, an operation panel 320, and a card interface (I/F) 330.

The control unit 200 is a computer including a CPU 210, a RAM 220, and a ROM 230. The control unit 200 controls constituent elements of the printer 100.

The print engine 300 is a print mechanism that performs a printing process on the basis of supplied print data. Various print mechanisms such as a print mechanism that forms an image by ejecting ink droplets onto a print medium and a print mechanism that forms an image by transferring and fixing toner on a print medium can be employed.

The display 310 displays various kinds of information such as an operational menu or an image in accordance with a command from the control unit 200. Various displays such as liquid crystal or organic EL displays can be employed.

The operation panel 320 receives an instruction of a user. The operation panel 320 may include operational buttons, a dial, and a touch panel, for example.

The card I/F 330 is an interface of a memory card MC. The control unit 200 reads an image file stored in the memory card MC through the card I/F 330. The control unit 200 then performs a printing process by use of the read image file.

FIG. 2 is a block diagram illustrating modules and data stored in the ROM 230 (see FIG. 1). In this embodiment, a facial area detecting module 400, a size calculating module 410, an image processing module 420, a print data generating module 430, and a model size table 440 are stored in the ROM 230. The modules 400-430 may be programs that are executed by the CPU 210. In addition, the modules 400-430 can transmit and receive data one another through the RAM 220. Functions of the modules 400-430 are described in detail below.

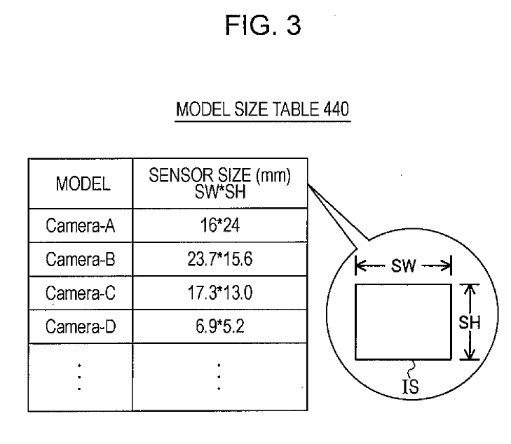

FIG. 3 is a schematic diagram including a model size table 440. The model size table 440 stores a correspondence relation between a model of an image generating device (for example, a digital still camera) and the size of the image pickup element (also called “a light-receiving unit” or “an image sensor”) of the model. In this embodiment, it is assumed that the shape of the light-receiving area of the image pickup element is rectangular. In addition, as the size of the image pickup element, a height SH (the length of a shorter side) and a width SW (the length of a longer side) of the light-receiving area (rectangular shape) are used. In this way, the size of the image pickup element is determined in advance in every model of the image generating device. Accordingly, a model is correlated with the size of the light-receiving area of the image pickup element (in this embodiment, the model corresponds to “image pickup element information” in claims).

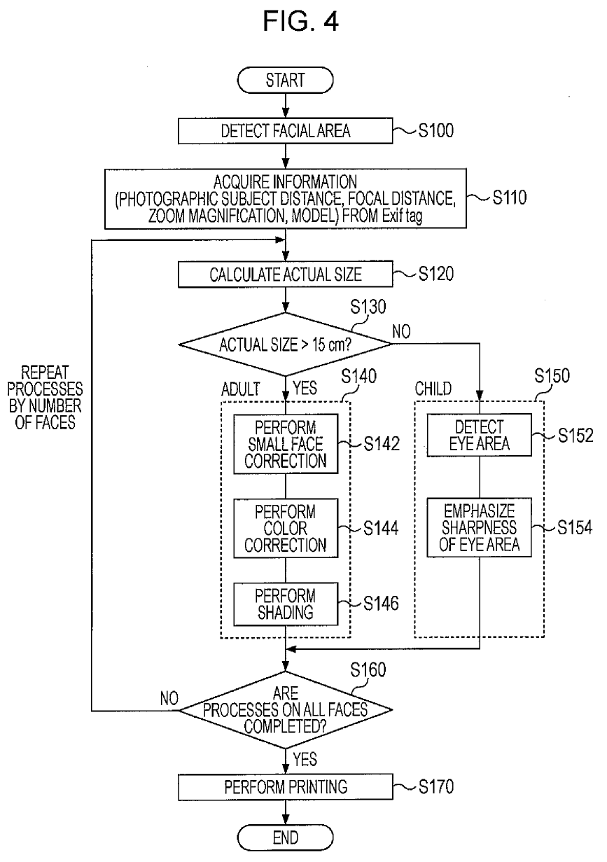

FIG. 4 is a flowchart of the printing process. The control unit 200 (see FIG. 1) starts the printing process in response to an instruction of a user input through the operation panel 320. In the printing process, the control unit 200 prints an image represented by image data contained in the image file designated by the instruction of the user. Hereinafter, the image file designated by the user is referred to as “a target image file”, the image data contained in the target image file is referred to as “target image data”, and the image represented by the target image data is referred to as “a target image”.

In Step S100, the facial area detecting module 400 detects a facial area from the target image by analyzing the target image data. The facial area is an area in the target image containing an image of at least a part of a face.

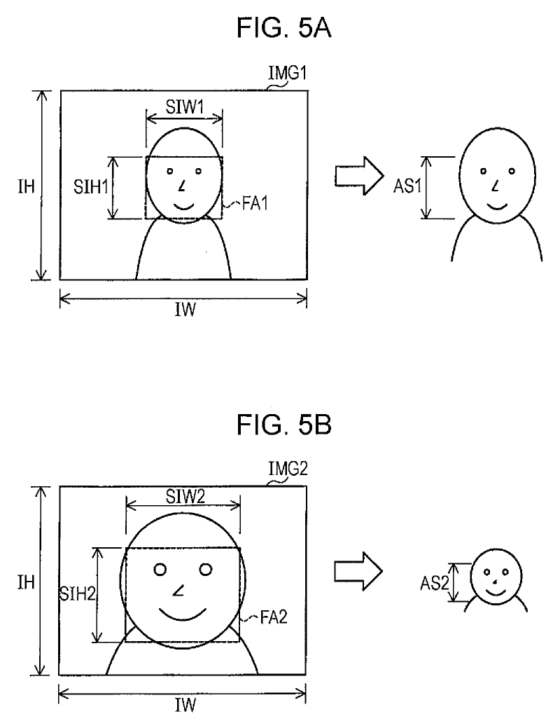

FIGS. 5A and 5B are schematic diagrams illustrating detection results of the facial areas. FIG. 5A shows a detection result detected from a first target image IMG1 representing an adult and FIG. 5B shows a detection result detected from a second target image IMG2 representing a child. A first facial area FA1 is detected from the first target image IMG1. A second facial area FA2 is detected from the second target image IMG2. As illustrated, in this embodiment, a rectangular area containing two eyes, a nose, and a mouth is detected as the facial area. When a small face is copied as in the first target image IMG1, a small facial area is detected. When a large face is copied as in the second target image IMG2, a large facial area is detected. The size of the facial area is correlated with the size on the target image of a face. An aspect ratio of the facial area may vary in accordance with a face within the target image. Alternatively, the aspect ratio of the facial area may be fixed. In addition, as the facial area to be detected, an arbitrary area containing an image of at least a part of a face may be used. For example, the facial area may contain the entire face.

In this embodiment, the target image has a rectangular shape. An image height IH and an image width IW of the rectangular shape refer to a height (a length of a short side) and a width (length of a long side) of the target image, respectively (where a unit is the number of pixels). A facial area height SIH1 and a facial area width SIW1 refer to the height and width of the first facial area FA1 (where a unit is the number of pixels). Likewise, a facial area height SIH2 and a facial area width SIW2 refer to the height and width of the second facial area FA2.

Various methods may be used as a method of detecting the facial area by the facial area detecting module 400. In this embodiment, the facial area is detected by a pattern matching technique using template images of eyes and a mouth as organs of a face. Alternatively, various pattern matching techniques using templates (for example, see JP-A-2004-318204) may be used.

In some cases, plural faces are contained in one target image. In this case, the facial area detecting module 400 detects plural facial areas from the one target image.

In step S110, the size calculating module 410 acquires relevant information from the target image file. In this embodiment, an image pickup device (for example, a digital still camera) creates an image file in conformity with, for example, an Exif (Exchangeable Image File Format) standard. The image file contains additional information such as a model of an image pickup device or a lens focal distance at the time of photographing an image in addition to image data. The additional information refers to information on the target image data.

In this embodiment, the size calculating module 410 acquires the following information from the target image file:
1) a subject distance;
2) a lens focal distance;
3) a digital zoom magnification; and
4) a model name.
   The subject distance represents a distance between an image pickup device and a subject at the time of photographing an image. The lens focal distance represents a lens focal distance at the time of photographing the image. The digital zoom magnification represents magnification of digital zoom at the time of photographing the image. In general, digital zoom is a process of cropping a peripheral portion of the image data and performing pixel interpolation on the remaining image data to form the original number of pixels. These kinds of information all represent setting of operations of the image pickup device at the time of photographing the image. The model name represents a model of the image pickup device. A general image pickup device creates image data by photographing an image and creates an image file containing the image data and additional information.

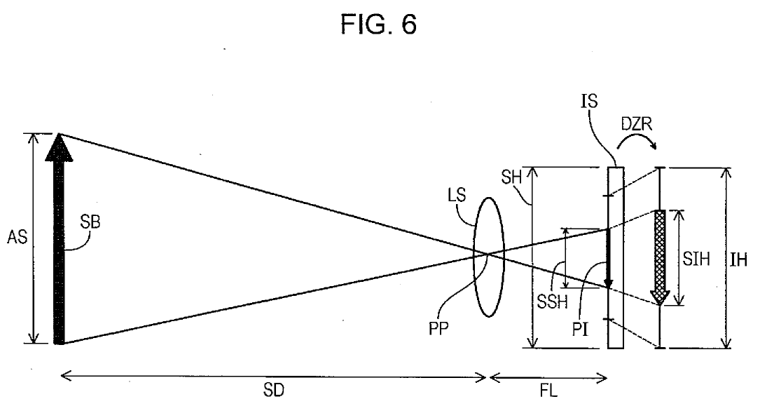

In Step S120, the size calculating module 410 calculates an actual size corresponding to the facial area. FIG. 6 is an explanatory diagram illustrating a relation between the number of pixels in an image and the actual size.

FIG. 6 is a side view illustrating a location relation among a subject SB, a lens system LS, and an image pickup element IS. The lens system LS may include plural lenses. Just one lens is illustrated in the lens system LS of FIG. 6 for simple illustration. In addition, FIG. 6 also shows the following constituent elements: an actual size AS (actual length) of the subject SB, a subject distance SD, a lens focal distance FL, a length (height SH) of the image pickup element IS, a photographed image PI shown in the subject SB which is formed on a light-receiving surface (imaging surface) of the image pickup element IS, a size (pixel number SSH in the height direction) of the photographed image (PI), a digital zoom magnification DZR, a size (a total pixel number IH in a height direction) of an image, and a size (pixel number SIH in the height direction) of the subject SB on the image.

The actual size AS of the subject SB represents a length in a height direction (corresponding to the height direction of the image pickup element IS). The subject distance SD acquired in Step S110 is almost equal to a distance between an optical center (principal point PP) of the lens system LS and the subject SB. The lens focal distance FL represents a distance between the optical center (principal point PP) of the lens system LS and the imaging surface on the image pickup element IS.

As is well known, a triangle defined by the principal point PP and the subject SB is similar to a triangle defined by the principal point PP and the photographed image PI. Accordingly, Expression (1) is established as follows:

AS:SD=SSH:FL (1),

where parameters AS, SD, SSH, and FL are represented in the same unit (for example, “cm”). In some cases, the principal point of the lens system LS viewed from a side of the subject SB may be different from principal point of the lens system LS viewed from a side of the photographed image PI. In FIG. 6, this difference is omitted since the difference therebetween is sufficiently small.

The size SIH of the subject SB in the image is the same as a value obtained by multiplying the size SSH of the photographed image PI by the digital zoom magnification DZR (SIH=SSH*DZR). The size SIH of the subject SB in the image is represented by the number of pixels. The height SH of the image pickup element IS corresponds to the total pixel number IH. From this relation, the size SSH of the photographed image PI satisfies Expression (2) in millimeter unit by using the number of pixels SIH:

SSH=(SIH*SH/IH)/DZR (2),

where the height SH of the image pickup element IS is expressed in millimeter unit.

From Expressions (1) and (2), the actual size AS of the subject SB is represented in Expression (3) as follows:

AS=(SD*100)*((SIH*SH/IH)/DZR)/FL (3),

where a unit of each parameter is set as follows. The actual size AS of the subject SB is represented in “cm” unit, the subject distance SD is represented in “m” unit, the height SH of the image pickup element IS is represented in “mm” unit, and the lens focal distance FL is represented in “mm” unit.

Based on Expression 3, the size calculating module 410 (see FIG. 2) calculates the actual size corresponding to the facial area. A first size AS1 shown in FIG. 5A represents the actual size calculated from the height SIH1 of the first facial area FA1. A second actual size AS2 shown in FIG. 5B represents the actual size calculated from the height SIH2 of the second facial area FA2. As described above, the size of the facial area has a correlation with the size on the target image of a face. Accordingly, the calculated actual size has a positive correlation with the actual size (for example, the length from the top of a head to a front end of a chin) of the face of the subject. That is, as the calculated actual size is larger, the actual size of the face of the subject is lager. In addition, the actual size corresponds to “a size reference value” in claims.

In Step S130, the image processing module 420 determines whether the calculated actual size is larger than 15 cm. When the actual size is larger than 15 cm, the image processing module 420 performs a process of Step S140. For example, the first actual size AS1 shown in FIG. 5A is set to be larger than 15 cm. In this case, for the image processing module 420 to process the first target image IMG1, the process proceeds to Step S140.

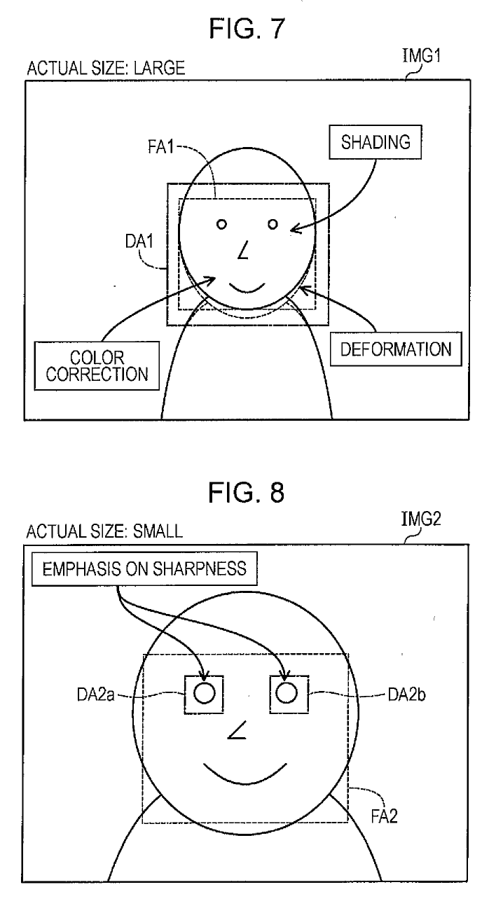

FIG. 7 is a schematic diagram illustrating the process of Step S140. As shown in FIG. 4, Step S140 includes three steps: Steps S142, S144, and S146.

In Step S142, a deformation process of reducing a face is performed. In this embodiment, the deformation process reduces a lower half-portion of the face. In other words, the deformation process narrows a line of the chin of the face. An image created by image pickup may give a viewer an impression that the width of the subject is wider than its actual width. The deformation process therefore makes the impression given to the viewer of the image approach the impression of the actual subject.

The image processing module 420 can execute the deformation process in accordance with various known methods. For example, the image processing module 420 may determine a deformation area representing a portion to be deformed and deform an image within the deformation area. The deformation area is a partial area containing the lower portion of the face. As the deformation area, for example, an area which is determined on the basis of the facial area in accordance with a predetermined rule can be used. For example, an area into which the facial area is enlarged in accordance with a predetermined rule can be used. In FIG. 7, a deformation area DA1 is set on the basis of the first facial area FA1. In addition, various methods can be used as a method of deforming an image within the deformation area DA1. For example, a method of dividing the deformation area DA1 into plural small areas in accordance with a predetermined pattern and magnifying or reducing the small areas in accordance with a predetermined rule can be used.

The deformation process may also be a process of reducing at least a part of a face. For example, the deformation process may reduce the width of a portion below eyes of the face, or may reduce the width of the entire face.

In Step S144 (see FIG. 4), a color correcting process of correcting a color of the face (particularly, the skin) is performed. The color correcting process causes an impression of the face (skin) color given to the viewer of the target image to approach an impression of the actual subject. For example, the skin color may be brightened or may approach a predetermined color. The image processing module 420 (see FIG. 2) selects pixels representing the skin color of the face as target pixels of the color correction. Various methods may be used as a method of selecting the target pixels. For example, the image processing module 420 may select skin color pixels within the facial area. Here, the skin color pixels represent a color in a predetermined range of a skin color. Alternatively, the image processing module 420 may select skin color pixels near the facial area together with the skin color pixels within the facial area.

In Step S146, a face (skin) shading process is performed. The shading process reduces noise in the target image. Various processes may be used as the shading process. For example, a process of reducing sharpness by use of a so-called unsharp mask may be used. In this embodiment, the image processing module 420 selects pixels representing the skin color of the face as the target pixels of the shading process. Various methods may be used to select the target pixels, such as the method of selecting the target pixels of the color correction (Step S144).

On the other hand, when the actual size is equal to or less than 15 cm, the image processing module 420 performs Step S150 (see FIG. 4). For example, the second actual size AS2 shown in FIG. 5B is set to be equal to or less than 15 cm. In this case, for the image processing module 420 to process the second target image IMG2, the process proceeds to Step S150.

FIG. 8 is a schematic diagram illustrating the process of Step S150. As shown in FIG. 4, Step S150 includes two steps: Steps S152 and S154.

In Step S152, the facial area detecting module 400 detects an eye area containing an eye image. The eye area is detected from the facial area detected in Step S100. In FIG. 8, two eye areas DA2a and DA2b are detected. In this embodiment, one eye area is set to contain one eye. The facial area detecting module 400 detects the eye areas like the detection of the facial area.

In Step S154, the image processing module 420 performs a sharpness emphasis process of emphasizing sharpness of the eye areas. In this way, the eyes of the target image are caused to be clear. Various processes may be used as the sharpness emphasis process. For example, a sharpness emphasis process of using a so-called unsharp mask may be used.

The size calculating module 410 and the image processing module 420 repeatedly perform Steps S120-S150 in every detected facial area. For example, when an adult and a child are copied in one target image, the image processing module 420 performs Step S140 on the face of the adult and Step S150 on the face of the child. When the processes on all the facial areas are completed (Step S160: Yes), the process proceeds to Step S170. Alternatively, when no face is detected, the size calculating module 410 and the image processing module 420 cancel the processes of Steps S120-S160.

In Step S170, the print data generating module 430 generates print data by use of the image data subjected to the processes performed by the image processing module 420. Any format of the print data suitable for the print engine 300 may be used. For example, in this embodiment, the print data generating module 430 generates the print data representing a print state of dots of each ink by performing a resolution conversion process, a color conversion process, and a halftone process. The print data generating module 430 supplies the generated print data to the print engine 300. The print engine 300 performs a printing process in accordance with the received print data. Then, the processes in FIG. 4 are completed. The print data generating module 430 and the print engine 300 collectively correspond to “a printing unit” in claims.

In this embodiment, the image processing module 420 (see FIG. 2) performs an image process in accordance with the actual size corresponding to the facial area. Accordingly, the image process is fitted to the actual size of a face and is thereby fitted to the characteristics of a subject. In particular, the image processing module 420 switches a process in accordance with whether the actual size is larger than a threshold value. Accordingly, the image processing module 420 can perform the process by distinguishing an adult face from a child face. The threshold value of the actual size is not limited to 15 cm, and other values may be used. In general, the threshold value is experimentally determined. A range in which the actual size is equal to or less than the threshold value corresponds to “a first range” in the claims, and a range in which the actual size is larger than the threshold value corresponds to “a second range”.

The image processing module 420 performs the sharpness emphasis process on the eye area, when the actual size is equal to or less than the threshold value (see S150 in FIG. 4). With such a sharpness emphasis process, the eyes are made clear. As a result, the impression of the child face on the target image can be made to approach the actual impression.

The sharpness emphasis process may be performed not only on the eye area but also on any portion of the face. For example, the sharpness emphasis process may be performed on a mouth area containing a mouth image. Moreover, the sharpness emphasis process may be performed on the entire face.

The process in Step S150 is not limited to the sharpness emphasis process, and other arbitrary processes may be used. For example, a process of deforming eyes to be larger may be used.

The image processing module 420 performs three processes (see S140 in FIG. 4), when the actual size is larger than the threshold value: a first process of reducing a face, a second process of correcting of the color of facial skin; and a third process of shading the facial skin. By performing these processes, the impression of the adult face on the target image approaches the actual impression.

One or two of the processes of Step S140 may be used rather than all three processes. For example, one may use just the process of reducing the face or just the process of shading the facial skin. Alternatively, two processes may be used. In addition, Step S140 is not limited to these processes and may use other processes.

In general, Step S140 preferably includes a process that is not performed in Step S150, and Step S150 preferably includes a process that is not performed in Step S140.

### B. Second Embodiment

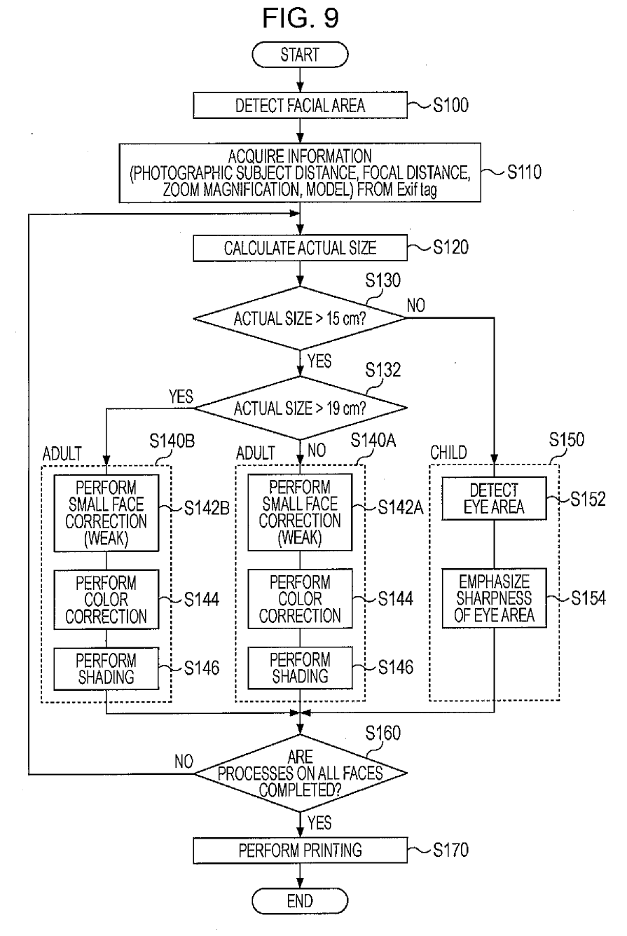

FIG. 9 is a flowchart of a second embodiment of a printing process. The printing processes of the first and second embodiments differ in that, in the second embodiment, the image processing module 420 performs processes (Steps S140A and S140B) in accordance with two ranges in which the actual sizes are different from each other when the actual size is larger than 15 cm. The remaining processes are the same as those of FIG. 4. In FIG. 9, the same reference numerals in FIG. 4 are given to steps in which the same processes as those in the steps of FIG. 4 are performed. The configuration of a printer is the same as that of the printer 100 shown in FIGS. 1 and 2 in the first embodiment.

The image processing module 420 (see FIG. 2) determines whether the actual size is larger than 19 cm in Step S132, when the actual size is larger than 15 cm. When the actual size is equal to or less than 19 cm, the image processing module 420 performs Step S140A. In Step S140A, a deforming process (S142A) of reducing a face, a color correction process (S144), and a shading process (S146) are included, as in Step S140 in FIG. 4.

Alternatively, when the actual size is larger than 19 cm, the image processing module 420 performs Step S140B. In Step S140B, a deforming process (S142B) of reducing a face, a color correction process (S144), and a shading process (S146) are also included, as in Step S140A. In this step, however, a deformation degree in the deforming process in Step S142B of Step S140B is stronger than that in the deforming process in Step S142A of Step S140A. That is, even in a case where the sizes in the target images of faces are equal to each other, the face subjected to the deformation process becomes thinner, when the actual size is larger.

In this embodiment, when the actual size is larger, an unpleasant impression by the viewer of the target image can be reduced thanks to the strong deformation. Moreover, when the actual size is a middle size, excessive deformation of the face is prevented, thanks to weak deformation.

The division number of the actual size may not be two shown in FIG. 4 or three shown in FIG. 9, but may be four or more. In any case, the deformation degree is preferably stronger with an increase in the actual size.

### C. Third Embodiment

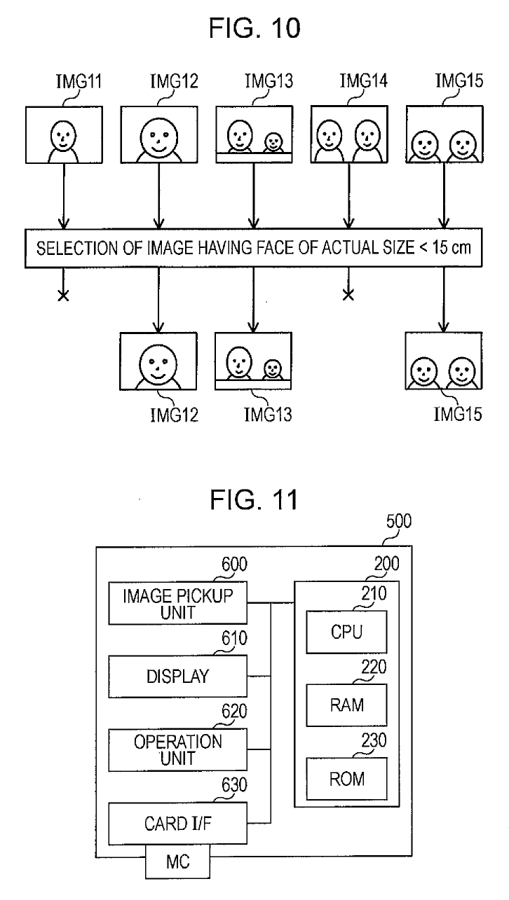

FIG. 10 is a schematic diagram illustrating a process on the basis of an actual size according to a third embodiment. In the third embodiment, the image processing module 420 (see FIG. 2) selects an image, from plural images, containing a face of which the actual size is less than a threshold value. The print data generating module 430 then generates print data by using the selected image (image data). The detection of the facial area, the calculation of the actual size, and the printing process are performed in the same manner as that in the embodiment of FIG. 4. As a result, an image into which a child is copied from the plural images can be automatically printed. In this embodiment, a range in which the actual size is less than the threshold value corresponds to “the first range” in claims. The process of selecting the image corresponds to “the first process” in claims. The threshold value is not limited to 15 cm, but other values may be used.

Arbitrary plural images prepared in advance may be used. For example, the control unit 200 (see FIG. 1) may automatically select the image from plural images (for example, the image file) stored in the memory card MC. Alternatively, the control unit 200 automatically selects the image from plural images selected in advance by a user.

The image processing module 420 may select an image containing a face of which the actual size is larger than the threshold value, instead of selecting the image containing the face of which the actual size is less than the threshold value. In this case, the image into which an adult is copied from plural images can be automatically printed. A range in which the actual size is larger than the threshold value corresponds to “the first range” in claims.

Use of the selection result by the image processing module 420 is not limited to the printing process. For example, the image file representing the selected image may be copied into a specific folder of the memory card MC.

### D. Fourth Embodiment

FIG. 11 is a block diagram of a digital still camera 500 according to a fourth embodiment. The digital still camera 500 includes a control unit 200, an image pickup unit 600, a display 610, an operational unit 620, and a card I/F 630.

The configuration of the control unit 200 is the same as in FIGS. 1 and 2. However, the print data generating module 430 and the model size table 440 (FIG. 2) may be omitted.

The image pickup unit 600 generates image data by image pickup. The image pickup unit 600 includes a lens system, an image pickup element, and an image data generator.

The display 610, the operation panel 620, and the card I/F 630 are the same as the display 310, the operation panel 320, and the card I/F 330 of FIG. 1.

The control unit 200 allows the image pickup unit 600 to perform image pickup in accordance with an instruction of a user. The image pickup unit 600 generates image data by the image pickup and supplies the generated image data to the control unit 200. The control unit 200 performs an image process by using the received image data and stores an image file containing the processed image data in a memory (for example, the memory card MC).

The same processes as those in the embodiments of FIGS. 4 and 9 may be used as the image process performed by control unit 200. In the fourth embodiment, however, the image processing module 420 (see FIG. 2) stores the image file in the memory card MC in Step S170, instead of printing. The size calculating module 410 acquires a subject distance, a lens focal distance, and a digital zoom magnification from the image pickup unit 600. The size calculating module 410 uses a predetermined value as the size of the image pickup element.

As described above, when the image process according to the actual size is applied to the image pickup performed by the digital still camera 500, an image suitable for the actual size of a face can be obtained by the image pickup.

### E. Modified Examples

Constituent elements other than those of the independent claims are additional elements and may be omitted from the embodiments described above. The invention is not limited to the embodiments described above, and may be modified in various forms without departing the scope of the invention. For example, the following modifications can be made.

### Modified Example 1

In the embodiments described above, the method of detecting the area containing the image of an organ such as a face, eyes, or a mouth from the target image is not limited to pattern matching. Other methods such as booting (for example, AdaBoost), a support vector machine, or a neural network, for example, may be used.

### Modified Example 2

In the embodiments described above, various values correlated with the actual size of a face may be used as the size reference value. For example, the size reference value may correspond to various sizes reflecting the size of a face. That is, the size reference value may correspond to various sizes correlated with a face. For example, as in the embodiment described above, the size reference value may correspond to the size of the facial area. Here, the length in a width direction (which corresponds to a direction of the longer side of the light-receiving area) of the image pickup element IS may be used. The size reference value may correspond to a distance between two locations obtained with reference to the locations of organs within a face. For example, the size reference value may correspond to a distance between a center portion of both eyes and a mouth. In any case, the size calculating module 410 can calculate the size reference value from various sizes (the sizes in the target image) reflecting the size of a face. For example, it is assumed that the size reference value corresponds to the distance between the center portion of both eyes and a mouth. In this case, the size calculating module 410 may calculate the size reference value from the distance (the number of pixels) between the center portion of both eyes and a mouth in the target image. Here, the size calculating module 410 may use the eyes and the mouth detected by the facial area detecting module 400. The size reference value is not limited to distance (length) and may correspond to other sizes such as area.

The information used to calculate the size reference value from the size (for example, length) in the target image reflecting the size of a face preferably includes the following information:

1) image pickup distance information on a distance from the image pickup device to a person at the time of photographing the target image,

2) focal distance information on the lens focal distance of the image pickup device at the time of photographing the target image, and

3) image pickup element information on the size of the portion in which the target image of the light-receiving area in the image pickup element of the image pickup device is generated.

In the embodiment of FIG. 6, the digital zoom magnification DZR is used in addition to these kinds of information. However, when image data generated by an image pickup device having no digital zoom function is used, the size calculating module 410 (see FIG. 2) may calculate the size reference value without using the digital zoom magnification DZR.

As the image pickup element information, a combination of a maker name and a model name may be used. In addition, some image pickup devices generate image data by cropping pixels of a peripheral portion of the image pickup element (entire light-receiving area) in accordance with an instruction of a user. When this image data is used, the size calculating module 410 can use the size (that is, the size of the portion in which the target image of the light-receiving area is created) of the light-receiving area occupied by the remaining pixels after the cropping instead of the size of the image pickup element (more specifically, the entire light-receiving area). The size calculating module 410 can calculate the size of this portion from a ratio of the size of the image data having the crop to the size (for example, a height or a width) of the image data having no crop and the size of the entire light-receiving area (this information is preferably specified by the image pickup element information). In addition, when the target image (target image data) is created without the crop, the entire light-receiving area of the image pickup element corresponds to the portion in which the target image is created. In any case, the image pickup element information preferably specifies at least one length of the longer side and the short side of the light-receiving area. When one length thereof is specified, the length of the other can be specified from the aspect ratio of the target image.

Some image pickup devices record a range of a focal distance in an image file, instead of the subject distance SD. When such an image file is used, the size calculating module 410 may use the range of the subject distance, instead of the subject distance SD. The range of the subject distance represents the subject distance with three levels, that is, “a macro”, “a close view”, and “a distant view”, for example. Accordingly, representative distances are set in advance in correspondence with the three levels and the size calculating module 410 can calculate the actual size by using the representative distances.

In general, as the method of calculating the size reference value, various methods of using the relevant information on the target image and the size (for example, a length) in the target image reflecting the size of a face may be used. Information that can determine a correspondence relation between the size (for example, a length in a unit of the number of pixels) in the target image and the actual size may be used as the relevant information. For example, the image pickup device may output a ratio of the actual length (for example, “cm”) to the length (the number of pixels) in an image. When this ratio is used, the size calculating module 410 can calculate the size reference value by using the ratio.

### Modified Example 3

In the embodiments described above, the specific process on the target image in accordance with the size reference value (the actual size in the embodiments described above) is not limited to the processes of FIGS. 4, 9, and 10, and other processes may be used. In general, the details of the process on the target image preferably vary in accordance with the size reference value. For example, in the embodiment of FIG. 4, Step S150 may be omitted. In this case, Step S140 corresponds to “the first process” in the claims. Instead, Step S140 may be omitted. In this case, Step S150 corresponds to “the first process” in the claims. In the embodiment of FIG. 9, one or two steps of Steps S140A, S140B, and S150 may be omitted. In any case, the process on the target image may be configured as a process of correcting the target image, as in the embodiment of FIG. 4 or 9. Alternatively, the process on the target image may be configured as a process of not correcting the target image, as in the embodiment of FIG. 10.

The image processing module 420 may perform the first process when the size reference value is within the first range. With such a configuration, the first process is intentionally performed on the image representing a face of the actual size corresponding to the size reference value within the first range. Wen the size reference value is out of the first range, the image processing module 420 preferably cancels the first process. In this way, the first process is not unintentionally performed on the image representing a face having the actual size corresponding to the size reference value out of the first range.

When the size reference value is within a second range that does not overlap with the first range, the image processing module 420 preferably performs the second process. In this way, a second process different from the first process is intentionally performed on the image representing the face of the actual size corresponding to the size reference value within the second range. Like the first process in the embodiment of FIG. 10, the second process may be a process of not correcting the target image. For example, the image processing module 420 may classify plural images into a first group in which the actual size is equal to or less than the threshold value and a second group in which the actual size is larger than the threshold value. In this case, the process of classifying the plural images into the first group corresponds to the first process and the process of classifying the plural images into the second group corresponds to the second process. The use of the classification result is arbitrary.

The range of the size reference value is not limited to a range less than a threshold value and a range larger than a threshold value. Ranges determined by upper and lower limit values may be used, for example.

### Modified Example 4

In the embodiments described above, the image processing apparatus performing the process in accordance with the size reference value is not limited to the printer 100 or the digital still camera 500. Other image processing apparatuses may be used Such as, for example, a general-purpose computer.

The configuration of the image processing apparatus is not limited to the configuration shown in FIG. 1 or 11, and other configurations may be used. In general, any configuration in which the facial area detecting module 400, the size calculating module 410, and the image processing module 420 are included may be used. For example, the image processing apparatus may acquire the target image data from an image generating device (for example, an image pickup device such as a digital still camera) through a communication cable or a network. In addition, the image processing apparatus may have a rewritable non-volatile memory in which the model size table 440 of FIG. 2 is stored. In addition, the size calculating module 410 may update the model size table 440. An update process in accordance with an instruction of a user and an update process of downloading a new model size table 440 through a network may be used, for example.

### Modified Example 5

In the embodiments described above, the image data to be processed is not limited to image data generated by a digital still camera (still image data), and image data generated by other image generating devices can be used. For example, image data generated by a digital video camera (moving picture data) may be used. In this case, modules 400, 410, and 420 of FIG. 2 preferably perform detection of a facial area, calculation of the size reference value, the process in accordance with the size reference value by using at least a part of plural frame images included in a moving picture as the target image. For example, the image processing module 420 may select a moving picture that includes a frame image representing a face of which the size reference value is less than the threshold value from plural moving pictures. In this way, a user can simply use the moving picture in which a child is copied by using the selected moving picture. In addition, selection of a moving picture that includes a target image (frame image) is also the process (a process on the target image) for the target image.

### Modified Example 6

In the embodiments described above, a part of the configuration implemented by hardware may be replaced to be implemented by software, or a part or the whole of the configuration that is implemented by software may be replaced to be implemented by hardware. For example, the function of the size calculating module 410 in FIG. 1 may be implemented by a hardware circuit having a logic circuit.

When a part or the whole of the function of an embodiment of the invention is implemented by software, the software (computer program) may be provided in a form in which the software is stored in a computer-readable recording medium. The “computer-readable recording medium” according to an embodiment of the invention is not limited to a portable recording medium such as a flexible disk or a CD-ROM and includes an internal storage device of a computer such as various types of RAMs and ROMs and an external storage device, which is fixed to a computer, such as a hard disk.

What is claimed is:

1. An image processing apparatus comprising:
a facial area detecting unit that detects a facial area containing an image of at least a part of a face of a person in a target image;
a size calculating unit that calculates a size reference value correlated with an actual size of the face by using the target image and relevant information on the target image; and
an image processing unit that performs a specific process on the target image in accordance with the size reference value.

2. The image processing apparatus according to claim 1, wherein the image processing unit performs a first process when the size reference value is present within a first range.

3. The image processing apparatus according to claim 2, wherein the image processing unit performs a second process different from the first process, when the size reference value is present within a second range that does not overlap with the first range.

4. The image processing apparatus according to claim 2, wherein the image processing unit performs as the first process a sharpness emphasis process on at least a part of the face in the target image.

5. The image processing apparatus according to claim 3, wherein the second range is broader than the first range and the image processing unit performs as the second process a process of reducing at least a part of the face in the target image.

6. The image processing apparatus according to claim 1,
wherein the target image is an image created by an image pickup device,
wherein the relevant information includes image pickup distance information on a distance from the image pickup device to the person at the time of photographing the target image, focal distance information on a lens focal distance of the image pickup device at the time of photographing the target image, and an image pickup element information on a size of a portion in which the target image of a light-receiving area in an image pickup element of the image pickup device is created, and
wherein the size calculating unit calculates the size reference value by using the relevant information and a size on the target image reflecting a size of the face.

7. A printer comprising:
a facial area detecting unit that detects a facial area containing an image of at least a part of a face of a person in a target image;
a size calculating unit that calculates a size reference value correlated with an actual size of the face by using the target image and relevant information on the target image;
an image processing unit that performs a specific process on the target image in accordance with the size reference value; and
a printing unit that prints the target image subjected to the specific process performed by the image processing unit.

8. An image processing method comprising:
detecting a facial area containing an image of at least a part of a face of a person in a target image;
calculating a size reference value correlated with an actual size of the face by using the target image and relevant information on the target image; and
performing a specific process on the target image in accordance with the size reference value.

9. An image processing computer program embodied on a computer-readable medium and causing a computer to execute:
a function of detecting a facial area containing an image of at least a part of a face of a person in a target image;
a function of calculating a size reference value correlated with an actual size of the face by using the target image and relevant information on the target image; and
a function of performing a specific process on the target image in accordance with the size reference value.
